(19) United States
(12) Patent Application Publication
(10) Pub. No.: US 2026/0050245 A1
(43) Pub. Date: Feb. 19, 2026

(54) TRANSFERRING OWNERSHIP OF A VIRTUAL MODEL OF A SMART DWELLING

(71) Applicant: SmartThings, Inc., Minneapolis, MN (US)

(72) Inventors: Mark Dennis Benson, Eagan, MN (US); Mark Allen Tekippe, Eagan, MN (US)

(73) Assignee: SmartThings, Inc., Minneapolis, MN (US)

(21) Appl. No.: 19/301,686

(22) Filed: Aug. 15, 2025

Related U.S. Application Data
(60) Provisional application No. 63/684,187, filed on Aug. 16, 2024.

(51) Int. Cl. G05B 15/02; G06Q 50/16; H04L 12/28

(52) U.S. Cl. CPC G05B 15/02; G06Q 50/167; H04L 12/2803; G05B 2219/2642

(57) ABSTRACT

Systems and methods for transferring ownership of virtual twins of smart dwellings are provided. In an aspect, a virtual twin of a smart dwelling maintains information associated with the smart dwelling, such as dwelling information, configuration information, and user preferences. The virtual twin may assist in a sale process for the smart dwelling. The virtual twin may additionally help a buyer of the smart dwelling during move-in, as the virtual twin already has information associated with the smart dwelling compiled and smart devices are already onboarded with the virtual twin. The virtual model further assists the buyer and the seller to ensure their privacy and security are protected after the transfer of ownership. In examples, ownership of the virtual twin is transferred substantially concurrently with a transfer of ownership of the smart dwelling.

### CROSS-REFERENCE TO RELATED APPLICATION(S)

This application claims the benefit of and priority to U.S. Application No. 63/684,187, filed on Aug. 16, 2024, titled TRANSFERRING OWNERSHIP OF A VIRTUAL MODEL OF A SMART DWELLING, the disclosure of which is hereby incorporated by reference in its entirety.

### BACKGROUND

Homeowners need to keep track of a variety of information relating to their home. For example, homeowners may manage the maintenance of each of their appliances, credentials for multiple accounts and devices, and settings for each of their devices, among other things. When homeowners sell their homes, buyers may ask the homeowners to compile this information and provide the information to the buyer. Without the homeowner providing this information, the buyer may need to independently rediscover this information, which is time consuming and inefficient due to the information already being known by others.

Additionally, when a home that has a plurality of smart devices is sold, the buyer must onboard and reconfigure each of the devices individually in order to gain control of the smart devices. This may be particularly difficult with smart devices that are in hard to access locations. For example, smart light switches may be installed within a wall. Onboarding information may also not be available for the buyer. For example, many smart devices include QR codes on the packaging that assist a user in onboarding the devices. The packaging, and therefore the QR codes, may have been thrown away or otherwise be inaccessible to the buyer, further complicating the onboarding process for the buyer. Further, the buyer may be unaware of some of the smart devices in the home, and therefore the buyer may be unable to onboard and use the unknown smart devices.

Further, when a home with smart devices is sold, both the buyer and the seller may have concerns regarding privacy and security. The buyer may have no way to ensure the seller no longer has access to the smart devices and is unable to snoop on the buyer in the home. Similarly, the seller may have concerns that not all of their personal information was properly removed from the smart devices.

### SUMMARY

In general terms, this disclosure is directed to transferring ownership of virtual twins of smart dwellings. In some embodiments, and by non-limiting example, a virtual twin of a smart dwelling maintains information associated with the smart dwelling, such as dwelling information, configuration information, and user preferences. In embodiments, ownership of the virtual twin is transferred substantially concurrently with a transfer of ownership of the smart dwelling. Transferring ownership of the virtual twin helps the transferee quickly and easily adjust to the smart dwelling. Information about the smart dwelling is already compiled in the virtual twin, and smart devices in the smart dwelling are already onboarded with the virtual twin, saving the transferee the work to individually reconfigure each of the smart devices.

In an aspect, a method for managing control of a virtual twin of a dwelling is provided. A virtual twin of a dwelling is generated. The virtual twin of the dwelling includes control of one or more smart devices in the dwelling. Fixtures are designated among the one or more smart devices in the dwelling. Control of the virtual twin of the dwelling is transferred from a seller to a buyer. The transferred control of the virtual twin of the dwelling includes control of the designated fixtures.

In another aspect, a system for managing control of a virtual twin of a dwelling is provided. The system includes one or more processors and one or more computer-readable storage devices storing data instructions. When executed by the one or more processors, the data instructions cause the system to generate a virtual twin of a dwelling, wherein the virtual twin of the dwelling includes control of one or more smart devices in the dwelling; designate fixtures among the one or more smart devices in the dwelling; and transfer control of the virtual twin of the dwelling from a seller to a buyer. The transferred control of the virtual twin of the dwelling includes control of the designated fixtures.

In another aspect, a non-transitory computer readable medium having data instructions stored thereon is provided. The data instructions, when executed by the one or more processors, cause the one or more processors to generate a virtual twin of a dwelling, wherein the virtual twin of the dwelling includes control of one or more smart devices in the dwelling; designate fixtures among the one or more smart devices in the dwelling; and transfer control of the virtual twin of the dwelling from a seller to a buyer. The transferred control of the virtual twin of the dwelling includes control of the designated fixtures.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example environment in which a virtual twin of a smart dwelling may operate.

FIG. 2 illustrates an example embodiment of a virtual twin.

FIG. 3 illustrates an example device list user interface in a virtual twin application.

FIG. 4 illustrates an example settings user interface in a virtual twin application.

FIG. 5 illustrates an example floorplan user interface in a virtual twin application.

FIG. 6 illustrates an example service provider user interface in a virtual twin application.

FIG. 7 illustrates an example account credentials user interface in a virtual twin application.

FIG. 8 illustrates another example environment in which a virtual twin of a smart dwelling may operate.

FIG. 9 illustrates an example fixture user interface in a virtual twin application.

FIG. 10 illustrates an example model transfer user interface in a virtual twin application.

FIG. 11 illustrates an example timeline of a sale process for a smart dwelling and a virtual twin.

FIG. 12 illustrates an example of a user permissions user interface in a virtual twin application.

FIG. 13 illustrates an example permission assignment user interface in a virtual twin application.

FIG. 14 illustrates an example notification associated with an assignment of permissions to a user.

FIG. 15 illustrates an example of a limited control user interface in a virtual twin application.

FIG. 16 illustrates a further environment in which a virtual twin may operate.

FIG. 17 illustrates a flowchart of an example method for managing ownership of a virtual twin of a smart dwelling.

FIG. 18 illustrates an example embodiment of a computing device.

FIG. 19 illustrates an example embodiment of a smart device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As used herein, the term “including” should be read to mean “including, without limitation,” “including but not limited to,” or the like. The term “substantially” as used herein is a broad term and is to be given its ordinary and customary meaning to a person of ordinary skill in the art (and is not to be limited to a special or customized meaning), and furthermore refers without limitation to being largely but not necessarily wholly that which is specified.

As used herein, the term “smart device” includes electronic devices that can connect to one or more other devices over a network. The term “smart dwelling” as used herein includes dwellings—such as houses, apartments, townhomes, hotel rooms, rental properties, and other similar living quarters—that include one or more smart devices. “Smart dwellings” as described herein may additionally include smart devices associated with the dwelling that are not physically located within the dwelling. For example, a smart doorbell may be located on the outside of a smart dwelling and smart sensors may be located on a fence surrounding the smart dwelling. Additionally, other property associated with the dwelling may be included with the smart dwelling, such as a car and any smart devices associated with the car.

As briefly described above, embodiments of the present disclosure are directed to a virtual twin of a smart dwelling. While examples described herein may refer to a specific type of dwelling, such as a smart home, the systems and methods described herein are applicable to any kind of dwelling, whether permanent or temporary, including homes, apartments, hotel rooms, and rental properties. Similarly, while transfers described herein describe transferring ownership of the virtual twin from a seller to a buyer during a sale of the smart dwelling, in other examples, the transfer of ownership of the virtual twin may occur for different reasons and to different transferees. For example, the virtual twin may transfer to a bank during a foreclosure.

In example aspects, a virtual twin of a smart dwelling is associated with and represents a dwelling. In embodiments, the virtual twin includes information associated with the smart dwelling and the devices in the smart dwelling. For example, the virtual twin may include dwelling information, configuration information, and user preferences, such as floorplans, device information and settings, and account credentials associated with the smart dwelling.

In examples, the virtual twin may increase the efficiency of a process to sell the smart dwelling. For example, the virtual twin may assist in generating a listing for the smart dwelling, showings, inspections, and walkthroughs, among other things. In another example, the virtual twin makes the move-in more efficient for a buyer as information about the smart dwelling is already compiled in the virtual twin.

In further examples, the virtual twin assists a buyer with setting up the smart dwelling after moving in. For example, because smart devices have already been onboarded with the virtual twin by the seller, the buyer does not need to individually onboard each of the smart devices.

Additionally, the virtual twin may provide assurance to both the buyer and the seller that their privacy and security is maintained after the transfer of ownership. For example, the seller can confirm that their personal information has been removed from the virtual twin and associated devices before ownership is transferred to the buyer. Similarly, the buyer can ensure that the seller no longer has access or control over the virtual twin and associated devices after ownership is transferred.

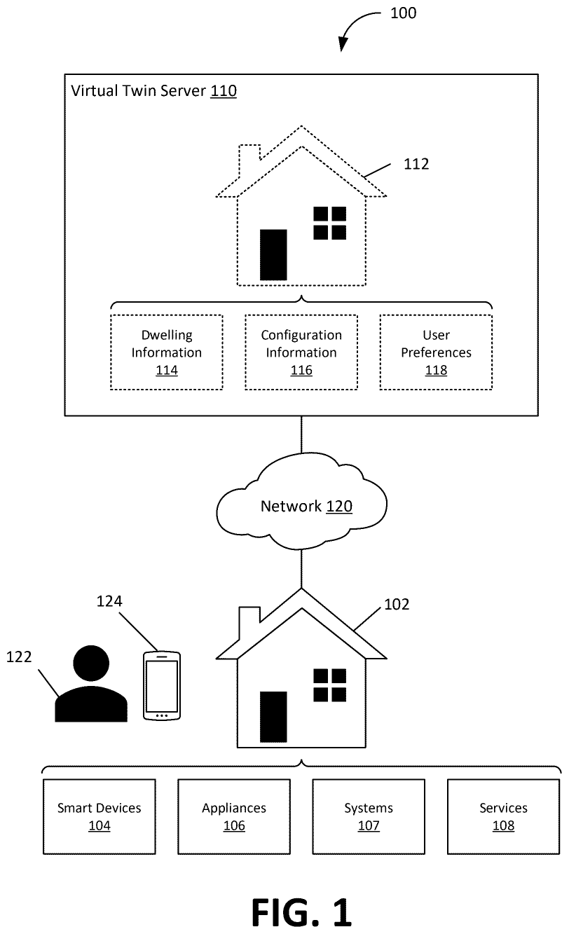

Turning now to FIG. 1, an example environment 100 for use of a virtual twin of a smart dwelling is shown. In the illustrated embodiment, the environment 100 includes a smart dwelling 102 and a virtual twin server 110.

The smart dwelling 102 includes smart devices 104, appliances 106, and other systems 107. Examples of appliances 106 include refrigerators, ovens, washing machines, and the like. Examples of systems 107 include electrical systems, plumbing systems, sprinkler systems, and the like. In some embodiments, an appliance 106 or a system 107 may also be a smart device—for example, a refrigerator may be a smart refrigerator (i.e., the refrigerator may be connected to a network of electronic devices). Similarly, a component of an appliance 106 or a system 107 may be a smart device—for example, a circuit breaker or an electrical panel in an electrical system may be a smart device. In the illustrated embodiment, services 108 are also provided to the smart dwelling 102, such as internet services and streaming services.

The virtual twin server 110 maintains a virtual twin 112 of the smart dwelling 102. In the illustrated embodiment, the virtual twin 112 includes dwelling information 114, configuration information 116, and user preferences 118 related to the smart dwelling 102 and the associated smart devices 104, appliances 106, and services 108. As described further herein, the virtual twin 112 provides a centralized platform for control and management of the smart devices 104, appliances 106, and services 108 associated with the smart dwelling 102. For example, a user 122 may use a mobile device 124 to connect to the virtual twin 112 to manage the smart devices 104 in the smart dwelling 102. In alternative examples, the user 122 may use a different computing device to connect to the virtual twin 112.

Further, the virtual twin 112 allows a user 122 to easily manage access for guests or other users to the smart devices 104, appliances 106, and services 108 associated with the smart dwelling 102. In an example, the user 122 may provide guest permissions to an agent, allowing the agent to control the smart dwelling and temporarily access smart devices 104, appliances 106, and services 108 during a showing of the smart dwelling 102.

While the virtual twin server 110 is illustrated as a single server in the illustrated embodiment, in alternative embodiments, the virtual twin server 110 includes a plurality of connected servers. For example, the virtual twin server 110 may include a distributed server network. Additionally, in some embodiments, the virtual twin server 110 may include one or more cloud servers or one or more edge servers, or a combination cloud and edge servers.

In the illustrated embodiment, the smart dwelling 102 connects to the virtual twin server 110 over a network 120, such as the Internet. In an example, a hub within the smart dwelling 102 connects to the virtual twin server 110 over the network 120. In an example, the mobile device 124 of the user 122 may act as a hub for the smart dwelling 102. In this example, the mobile device 124 may connect to the virtual twin server 110 and the smart devices 104 in the smart dwelling 102 to act as an intermediary between the smart devices 104 and the virtual twin 112. In another example, a smart device 104 may similarly act as a hub for the smart dwelling 102.

While not shown for ease of illustration, the environment 100 may include multiple networks. For example, a local network within the smart dwelling 102 may connect the smart devices 104 and appliances 106, and the network 120 may connect the smart dwelling 102 to the virtual twin server 110.

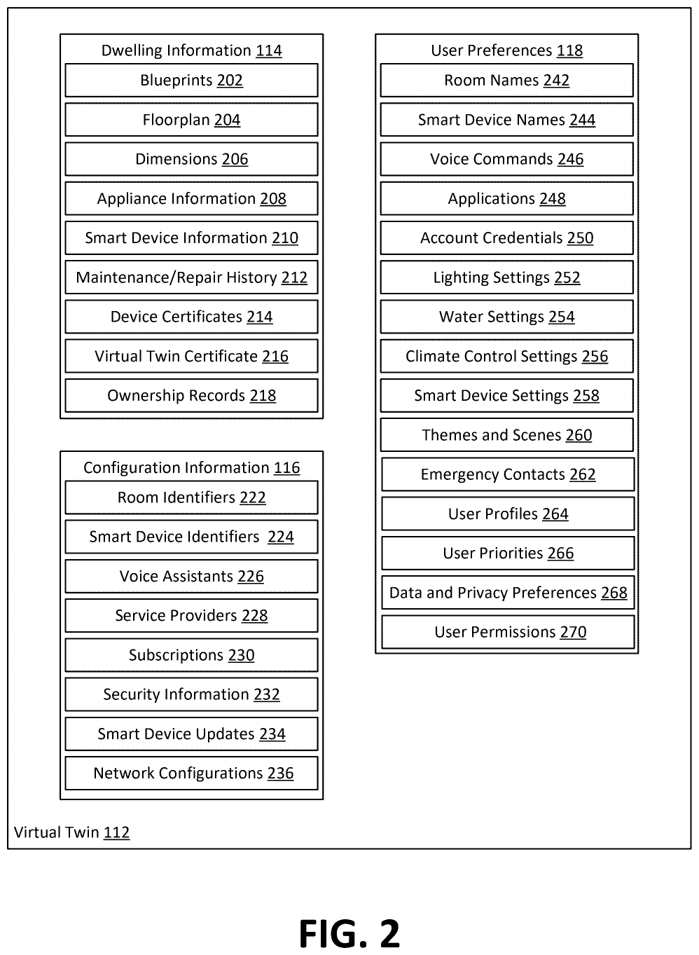

FIG. 2 illustrates an example embodiment of a virtual twin 112. As described briefly above, the virtual twin 112 includes dwelling information 114, configuration information 116, and user preferences 118 associated with a smart dwelling and associated smart devices, appliances, and services. While the embodiment shown in FIG. 2 includes examples of the data included in the virtual twin 112, in alternative embodiments, additional or alternative data may be included in the virtual twin 112. In embodiments, the virtual twin 112 may include any data associated with a smart dwelling. Similarly, in some embodiments, the virtual twin 112 includes a subset of the information illustrated in FIG. 2. For example, in an embodiment, the virtual twin 112 may include blueprints 202 but not floorplans 204.

The dwelling information 114 includes data associated with substantially static elements of a smart dwelling—i.e., elements of the smart dwelling that are not frequently changed. Examples of infrastructure include blueprints 202, floorplans 204, and dimensions 206 for the smart dwelling, appliance information 208, smart device information 210, maintenance and repair histories 212, device certificates 214, and a virtual twin certificate 216. In some embodiments, the dwelling information 114 may include any digital documentation associated with the smart dwelling, including inspection records, appraisals, titles, liens, and tax assessments.

Blueprints 202, floorplans 204, and dimensions 206 describe a physical layout of the smart dwelling associated with the virtual twin 112. In an example, the blueprints 202, floorplans 204, and dimensions 206 are added to the virtual twin 112 by user input. For example, a user (e.g., an owner of the smart dwelling, a builder of the smart dwelling, or a virtual twin technician) may upload documents describing the blueprints 202, floorplans 204, and dimensions 206 to the virtual twin server 110 for inclusion in the virtual twin server 110. Documents imported from an external data source (e.g., a real estate database or a home builder database) may similarly be used for the blueprints 202, floorplans 204, and dimensions 206. In another example, the blueprints 202, floorplans 204, and dimensions 206 are determined based on images of the smart dwelling, such as two-dimensional images or three-dimensional scans of the smart dwelling. In further examples, a user may manually draw the floorplan 204 of the smart dwelling.

Appliance information 208 and smart device information 210 describe information related to appliances and smart devices, respectively, in the smart dwelling. Examples of appliance information 208 and smart device information 210 include model names, model numbers, serial numbers, information describing components of the appliance/smart device (e.g., appliance filter specifications and smart device battery types and statuses), network addresses (e.g., IP addresses), manufacturing dates, installation dates, registration dates (i.e., dates on which the appliances/smart devices were registered with the virtual twin 112), onboarding information (e.g., a QR code or other code used to onboard a smart device), data collected by the associated appliances and smart devices, device states, device histories, and warranty information. In an example, the appliance information 208 and the smart device information 210 is added to the virtual twin 112 manually by a user. In another example, the virtual twin 112 may communicate with appliances/smart devices to retrieve appliance information 208 and smart device information 210 automatically from the appliances/smart devices.

Maintenance and repair histories 212 describe maintenance and repairs performed on the smart devices and appliances in the smart dwelling. For example, the maintenance and repair histories 212 may include a maintenance log describing types of maintenance performed, dates of maintenance, and repair person information. In embodiments, the maintenance and repair histories 212 may be added to the virtual twin 112 by a user. For example, an owner of the smart dwelling may give a repair person access to add maintenance logs to the maintenance and repair histories 212.

In embodiments, the maintenance and repair histories 212 may be used to generate automatic maintenance reminders. For example, a filter for an HVAC system may need to be replaced every six months. In this example, the virtual twin 112 may determine that the maintenance log for the HVAC system has not been updated in the past six months and generate a reminder for the user to replace the filter. In another example, the reminder may be generated before the maintenance is due so that the user has time to schedule the maintenance (e.g., the virtual twin may generate a reminder to change the HVAC filter if it has not been changed in the past five months so that the user can schedule maintenance before the six-month date).

Device certificates 214 include certificates and similar authentication and cryptographic documents for the smart devices of the smart dwelling. In examples, the device certificates 214 include electronic documents that can be used to authenticate the associated smart devices'identities and the identity of the owner of the smart devices. In some embodiments, the device certificates 214 include a copy of the authentication documents from the smart devices. In embodiments, the device certificates 214 include metadata associated with the authentication documents from the smart devices. The virtual twin 112 may communicate with the smart devices to retrieve the authentication documents and metadata automatically from the smart devices.

Virtual twin certificates 216 includes similar authentication documents to the device certificates 214. In an example, the virtual twin certificate 216 includes an authentication document to authenticate the virtual twin 112 and an owner of the virtual twin 112. In another example, the virtual twin certificates may additionally include a digital version of a title to the smart dwelling. In an embodiment, the virtual twin certificate 216 is created upon initialization of the virtual twin 112. In an example, an external certificate service creates the virtual twin certificate 216. In some embodiments, the virtual twin certificates 216 may be stored in or linked to a public ledger (e.g., a distributed blockchain) or another database. By storing/linking the virtual twin certificates 216 to a public ledger or another database, transfer of the virtual twin 112 to another owner may be facilitated-for example, when the smart dwelling is sold.

Ownership records 218 include information about past and current owners of the virtual twin 112. In some examples, the ownership records 218 include information about past and current owners of the smart dwelling. In embodiments, the ownership records 218 may be used to verify that the owner of the virtual twin 112 is a legitimate owner of the virtual twin 112. In an example, the ownership records 218 may be used in conjunction with the virtual twin certificate 216 to confirm ownership of the virtual twin 112. In an embodiment, the ownership records are maintained across a secure, public, distributed blockchain ledger. In such embodiments, the virtual twin 112 may include a reference to the ownership records in the distributed ledger.

The configuration information 116 includes data associated with a configuration of the virtual twin 112 and the smart dwelling. In an example, the configuration information 116 is not specific to a user. In the illustrated embodiment, the configuration information 116 includes room identifiers 222, smart device identifiers 224, voice assistants 226, service providers 228, subscriptions 230, security information 232, smart device updates 234, and network configurations 236.

Room identifiers 222 include identifiers for rooms in the smart dwelling. In an example, the room identifiers 222 may be associated with the blueprints 202 and floorplan 204. In an embodiment, the room identifiers are generated for rooms in the smart dwelling when blueprints 202 or a floorplan 204 are added to the virtual twin 112. In an example, a room identifier 222 for a room in the smart dwelling may be defined as “Room 1” or “Bedroom 1.” As described further herein, user preferences 118 may be set by a user to personalize a name for the room.

Smart device identifiers 224 include information to identify smart devices in the smart dwelling. In an example, the smart device identifications 224 include names for the smart devices and locations of the smart devices within the smart dwelling (e.g., what room the smart device is located in). For example, a smart device may have a name defined as “Television 1” and a location defined as “Room 1” in the smart device identifiers 224. In an embodiment, a user inputs the smart device identifications 224 into the virtual twin 112. In another embodiment, some information included in the smart device identifiers 224 may be automatically retrieved from a smart device when the smart device is registered with the virtual twin 112. For example, a type of smart device may be automatically retrieved from the smart device, and the smart device identifier 224 may be generated based on the retrieved device type. As described further herein, user preferences 118 may be set by a user to personalize a name for a smart device.

Voice assistants 226 include registered software for processing voice commands of a user, such as voice assistants or AI large-language models (LLMs). Examples of voice assistants 226 include Bixby® from Samsung® and other popular voice assistants. A user may register selected voice assistants 226 with the virtual twin 112 and configure the virtual twin 112 to use one or more voice assistants 226.

Service providers 228 include identifiers of service providers that provide services to the smart dwelling. Contact information of service providers may additionally be included in the service providers 228. Examples of service providers 228 include trash services, electricity services, water services, gas services, internet services, repair services, and television services (e.g., cable or satellite services). A user may add service providers 228 to the virtual twin 112. In another example, service providers 228 may automatically be added to the virtual twin 112 based on the maintenance and repair histories 212. For example, if a repair person from a service provider adds a maintenance log, the virtual twin may automatically register the service provider with the service providers 228 in the virtual twin 112. By maintaining a registry of service providers 228, users (such as a current owner of the smart dwelling, a further owner of the smart dwelling, or a designated caretaker of an individual living in the smart dwelling) can easily understand which service providers have been used or are preferred.

Subscriptions 230 include information associated with subscriptions to services for the smart dwelling. In an example, the subscriptions 230 may be associated with the service providers 228 described above. For example, the subscriptions 230 may include subscriptions for trash services, electricity services, water services, gas services, internet services, repair services, and television services. In an embodiment, the subscriptions 230 may include start and end dates of the subscriptions, prices of the subscriptions, payment information associated with the subscriptions, and renewal options for the subscriptions.

Security information 232 includes information associated with security devices in the smart dwelling. In an example, the security information 232 includes passcodes for smart locks and codes to arm and disarm an alarm system.

Smart device updates 234 include software and firmware updates to smart devices in the smart dwelling. In an embodiment, the virtual twin 112 may receive smart device updates 234 from a third-party server. For example, the virtual twin server 110 may connect to a server of a manufacturer of a smart device and receive updates for the smart device from the manufacturer server. The virtual twin 112 may then push the update to the corresponding smart device.

Network configurations 236 include information associated with network infrastructure in the smart dwelling. For example, the network configurations 236 may include information associated with a wireless network (e.g., a Wi-Fi network) within the smart dwelling. In an example, the network configurations 236 may be retrieved from a router, modem, or other smart device within the smart dwelling. In another example, a user may input information for a network configuration 236.

The user preferences 118 include data associated with personalization of the virtual twin 112 and the smart dwelling by the user. In the illustrated example, the user preferences 118 include room names 242, smart device names 244, voice commands 246, applications 248, account credentials 250, lighting settings 252, water settings 254, climate control settings 256, device settings 258, themes and scenes 260, emergency contacts 262, user profiles 264, user priorities 266, data and privacy preferences 268, and user permissions 270.

Room names 242 include personalized names for rooms in the smart dwelling. As described above with the configuration information 116, rooms may be assigned room identifiers 222 such as “Room 1” when the floorplan 204 is registered with the virtual twin 112. The room names 242 may be associated with the floorplan 204 and the room identifiers 222 and allow a user to personalize the names of the rooms. For example, if “Room 1” (as identified in the room identifiers 222) is a bedroom belonging to Janet, a user may set a name for the room to be “Janet's Bedroom.”

Smart device names 244 similarly include personalized names for smart devices in the smart dwelling. As described above with the configuration information 116, smart devices may be assigned smart device identifiers 224 such as “Television 1” when the smart devices are registered with the virtual twin 112. The smart device names 244 may be associated with the smart device identifiers 224 and allow a user to personalize the names of the smart devices. For example, if “Television 1” (as identified in the smart device identifiers 224) is a television in a living room, a user may set a name for the television to be “Living Room Television.”

Voice commands 246 include commands registered by the user for controlling aspects of the virtual twin 112 or smart dwelling by speaking. For example, the voice commands 246 may include commands to control smart devices in the smart dwelling. In an example, a user may register a voice command 246 so that when the user says “turn on the living room lights,” the lights in the living room of the smart dwelling turn on. The voice commands 246 may be set by a user of the virtual twin 112. In an example, the user registers voice commands 246 with smart devices, and the virtual twin 112 pulls the voice commands 246 from the smart devices. In an alternative example, the user registers the voice commands 246 with the virtual twin 112, and the virtual twin 112 pushes the voice commands 246 to the appropriate smart devices. In embodiments, the voice commands 246 may be associated with specific voice assistants 226.

Applications 248 include software applications and other programs that can be executed by the virtual twin 112 or by smart devices, appliances, or other systems in the smart dwelling. Examples of applications 248 include streaming applications, games, and applications for controlling accounts of a user. In embodiments, applications 248 are registered with the virtual twin 112 by a user. For example, users may download applications from an application store. The applications 248 may additionally or alternatively include artificial intelligence or machine learning models that operate on the virtual twin 112 or associated smart devices, appliances, or other systems. Examples of artificial intelligence and machine learning models include voice recognition or camera-based facial recognition models operating on camera-feeds in the smart dwelling, preventive maintenance models that detect faults or issues with smart devices, appliances and systems in the smart dwelling and notify users (e.g., an owner of the smart dwelling or a service provider) if an issue is detected, and models that analyze smart dwelling data to detect if someone is present in the home, how many people are in the home, or who is in the home.

Applications 248 may additionally or alternatively include third-party applications that can control the virtual twin. A third-party server associated with an application 248 may connect to the virtual twin 112 to control aspects of the virtual twin 112 or the smart dwelling when conditions are satisfied. For example, the applications 248 may include a ride-sharing application that is given permission to control lights in the smart dwelling when a driver arrives at the smart dwelling.

Account credentials 250 include user credentials for accessing accounts associated with the virtual twin 112. In examples, the account credentials 250 include credentials to access applications 248 and accounts associated with service providers 228 or subscriptions 230. In an embodiment, a user registers the account credentials 250 with the virtual twin 112.

Lighting settings 252 include settings for controlling lights within the smart dwelling. For example, lighting settings 252 may define an illumination intensity and color for lighting within a room of the smart dwelling. In another example, lighting settings 252 may include defined time ranges during which lights are turned on within the smart dwelling. In embodiments, a user sets the lighting settings 252 within the virtual twin 112. In some embodiments, the user sets lighting settings 252 with smart devices, and the virtual twin 112 pulls the lighting settings 252 from the smart devices.

Water settings 254 include settings for controlling water within the smart dwelling. For example, water settings 254 may define a temperature and volume of water to be dispensed by a sink or a shower within the smart dwelling. In embodiments, the water settings 254 may include set times at which water is dispensed. For example, the water settings 254 may define that eight ounces of water are dispensed by a kitchen faucet each morning at 6:15 AM. In an embodiment, a user sets the water settings 254 within the virtual twin 112. In some embodiments, the user sets water settings 254 with smart devices, and the virtual twin 112 pulls the water settings 254 from the smart devices.

Climate control settings 256 include settings for controlling the climate within the smart dwelling. For example, climate control settings 256 may control temperature and ventilation within the smart dwelling. In embodiments, the climate control settings 256 define time ranges during which different temperatures are set. For example, during the day, a temperature for the smart dwelling may be set at 71° F., and overnight, the temperature for the smart dwelling may be set at 69° F. In an embodiment, a user sets the climate control settings 256 within the virtual twin 112. In some embodiments, the user sets climate control settings 256 with smart devices, and the virtual twin 112 pulls the climate control settings 256 from the smart devices.

Smart device settings 258 include settings for smart devices in the smart dwelling. The smart device settings 258 define how the smart devices operate. In some embodiments, the smart device settings 258 may include lighting settings 252, water settings 254, and climate control settings 256. In an example, a user sets the smart device settings 258 with the corresponding devices, and the virtual twin 112 pulls the smart device settings from the smart devices. In other embodiments, the user sets the smart device settings 258 with the virtual twin 112, and the virtual twin 112 pushes the smart device settings 258 to the appropriate devices.

Themes and scenes 260 include defined styles and appearances for the virtual twin 112 and the smart dwelling. In an embodiment, the themes and scenes 260 may define colors and other aesthetic attributes of the virtual twin 112. For example, the themes and scenes 260 may describe appearances of a user interface associated with the virtual twin 112. In another example, the themes and scenes 260 include device settings 258 for smart devices in the smart dwelling. In an embodiment, a user defines the themes and scenes 260 in the virtual twin 112. In some embodiments, the user may download themes and scenes 260 from an online repository of themes and scenes. For example, the online repository of themes and scenes may include themes and scenes 260 created by other users.

Emergency contacts 262 include contact information for individuals who are contacted in case of an emergency (e.g., a medical emergency). In an example, the emergency contacts 262 include a phone number of a designated emergency contact. In embodiments, a user enters the emergency contacts 262 in the virtual twin 112.

User profiles 264 include information about users of the virtual twin 112, such as an owner of the smart dwelling. In an example, a user profile 264 includes biographical data about a user, such as a name, age, and gender. In another example, the user profile 264 may include interests and hobbies of the user. Information in the user profiles 264 may be entered by a user. The user profiles 264 may be used to personalize the virtual twin 112 for the users and generate recommendations for the users.

User priorities 266 include information about priorities of the users of the virtual twin 112. Examples of priorities that may be included in the user priorities 266 include energy savings, cost efficiency, comfort, convenience, security, and privacy. In an embodiment, a user may define the user priorities 266. In an alternative embodiment, user priorities 266 may additionally or alternatively be determined automatically by the virtual twin 112 based on other data in the virtual twin 112, such as smart device settings 258.

In some examples, the virtual twin 112 may automatically modify lighting settings 252, water settings 254, climate control settings 256, and smart device settings 258 based on user priorities 266. Additionally, as described further herein, the user priorities 266 may be used to personalize the virtual twin 112 and generate recommendations.

Data and privacy settings 268 include settings defining how data is handled in the virtual twin 112. For example, the data and privacy settings 268 may define what information is stored in the virtual twin 112, how long the data is stored in the virtual twin 112, how the data in the virtual twin 112 can be used, how PII and private information is handled in the virtual twin 112, and who can use the data in the virtual twin 112. In an example, in some embodiments, recommendations may be generated for a virtual twin 112 based on a similar virtual twin. The data and privacy settings 268 may allow a user to determine whether data in the virtual twin 112 can be used to provide recommendations for other virtual twins. In an embodiment, a user may set the data and privacy settings 268.

User permissions 270 include permissions for users to manage the virtual twin 112 and smart devices within the smart dwelling. As described further herein, the user permissions 270 may define what smart devices a user has access to and how the user can use the smart devices. For example, a first user may have permissions allowing the first user to access a Wi-Fi network in the smart dwelling. The user permissions 270 may be set by a user of the virtual twin 112, such as an owner of the smart dwelling.

While the illustrated embodiment shows the data included in the virtual twin 112 distributed into three categories (i.e., dwelling information 114, configuration information 116, and user preferences 118), in alternative embodiments, the data included in the virtual twin 112 may be organized in different configurations. For example, all of the data associated with a smart device (e.g., smart device information 210, device certificates 214, smart device identification 224, smart device updates 234, and smart device settings 258) are stored together.

Similarly, while the illustrated embodiment presents lighting settings 252, water settings 254, climate control settings 256, and smart device settings 258 separately in the user preferences 118, in some embodiments, the smart device settings 258 may include the lighting settings 252, water settings 254, and climate control settings 256 that are relevant for the smart device. For example, the smart device settings 258 for a smart faucet may include water settings 254.

Further, virtual twin 112 may track what data maintained therein is personal identifiable information (PII) or otherwise private information. As described further herein, ownership of the virtual twin 112 may transfer (e.g., from a seller of the smart dwelling to a buyer). During this transfer of ownership, to protect the privacy of the seller, some data may be cleared from the virtual twin 112, including PII and other private information. While much of the PII and private information may be included in the user preferences 118, the dwelling information 114 and the configuration information 116 may also include PII and private information. In an example, smart device information 210 may include data collected from smart devices that may be PII or private information. For example, a smart doorbell may include a camera that captures and stores images of individuals approaching the smart dwelling. The virtual twin 112 may track this data and similar private data so that when PII and private data needs to be cleared from the virtual twin 112, the virtual twin 112 can appropriately manage the data maintained therein.

Additionally, while the virtual twin 112 is shown as being maintained on a single virtual twin server 112 in the illustrated embodiment, in some embodiments, the data included in the virtual twin 112 is maintained across a distributed server network.

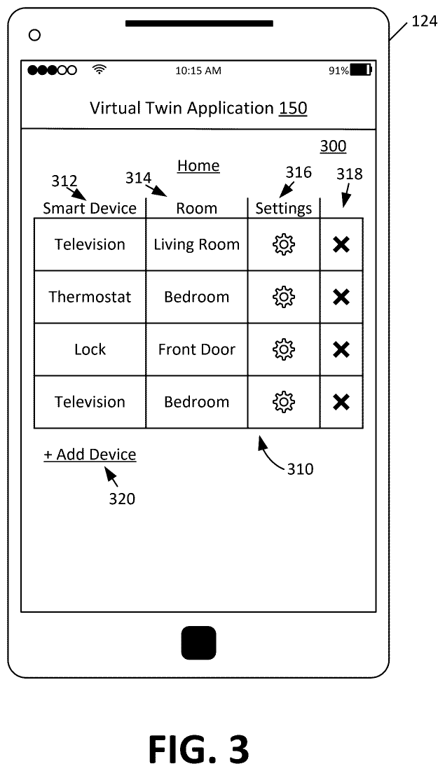

Turning now to FIGS. 3-7, example user interfaces for interacting with a virtual twin of a smart dwelling are shown. The user interfaces allow a user to add information to the virtual twin. Further, through the user interfaces, the user can interact with the virtual twin to manage aspects of the smart dwelling. In examples described herein, the user interfaces are shown in a virtual twin application 150 on a mobile device 124. In alternative embodiments, the user interfaces may be shown through other programs, such as a web interface, or on other computing devices. In an example, users may have a virtual twin account with the virtual twin application to view virtual twins for which they have access.

FIG. 3 illustrates an example device list user interface 300 presenting a list 310 of smart devices registered in a smart dwelling. In embodiments, the user interface 300 is shown to owners of the smart dwelling, and guests or other users who are granted limited permissions by the owner may be shown a different user interface, as described further herein.

In the illustrated embodiment, the list 310 of smart devices includes a device name 312, a location 314 of the smart device in the smart dwelling, a settings option 316, and a delete option 318. The user interface 300 also includes an option 320 to register an additional smart device. As described above, the device name 312 and location 314 may be entered by a user when the device is registered with the virtual twin and may be maintained as configuration information. The settings option 316 links to a settings user interface for the device. As described further herein, the settings user interface allows a user to modify settings for the associated device, such as changing the device name 312 or location 314. The delete option 318 allows a user to remove a smart device from the list 310 of registered smart devices.

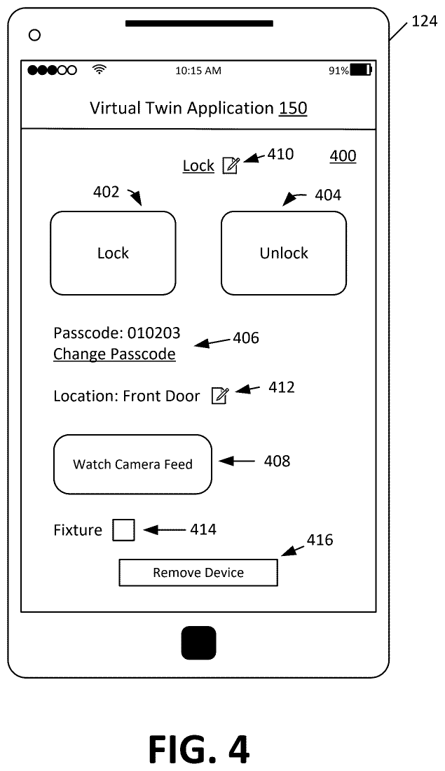

FIG. 4 illustrates an example of a settings user interface 400 for a smart device. In the illustrated example, the settings user interface 400 includes settings for a lock. In alternative embodiments, the settings user interface 400 may include different settings. For example, the settings user interface 400 may present settings for a different type of smart device; the settings presented in the settings user interface 400 may be different based on the smart device for which the settings user interface 400 is presented.

Additionally, the settings user interface 400 shown in the illustrated embodiment may be shown to an owner of the smart dwelling. In embodiments in which the settings user interface 400 is shown to guests or other users who are granted limited permissions by the owner, the settings user interface 400 may include different settings options.

In embodiments, the settings user interface 400 includes controls for the smart device (i.e., the smart lock). In examples, the settings set within the settings user interface 400 are saved as user preferences within the virtual twin. In the illustrated embodiment, the settings user interface 400 includes buttons 402, 404 that allow the user to lock and unlock the smart lock, respectively. The settings user interface 400 further includes an option 406 to change the passcode for the smart lock and watch a camera feed 408 from the smart lock through the virtual twin application 150. Additionally, the settings user interface 400 includes options 410, 412 to edit a name of the smart lock and edit a location of the smart lock within the smart dwelling. In the illustrated embodiment, the settings user interface 400 includes an option 414 to designate the smart device as a fixture and an option 416 to remove the smart lock from the virtual twin.

In alternative embodiments, the settings user interface 400 may include additional settings options. For example, the settings user interface 400 may include options to add or change any of voice commands, lighting settings, water settings, and climate control settings. The options presented in the settings user interface 400 may depend on the device for which the settings are being changed.

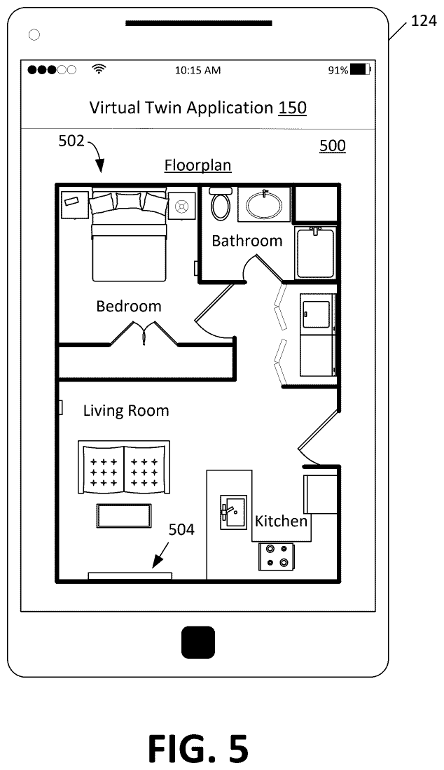

FIG. 5 illustrates a floorplan user interface 500 for presenting a floorplan of the smart dwelling. A similar user interface may be used to present blueprints of the smart dwelling. In the illustrated embodiment, the floorplan user interface 500 allows users to name rooms within the smart dwelling on the floorplan 502. As described above, room names may be maintained within the virtual twin as configuration information. Similarly, in some embodiments, the floorplan user interface 500 may include options for users to add smart devices to rooms shown in the floorplan 502. For example, in the illustrated embodiment, a user may indicate that a smart television 504 is located within the living room. Appliances and other devices may similarly be identified within the floorplan user interface 500.

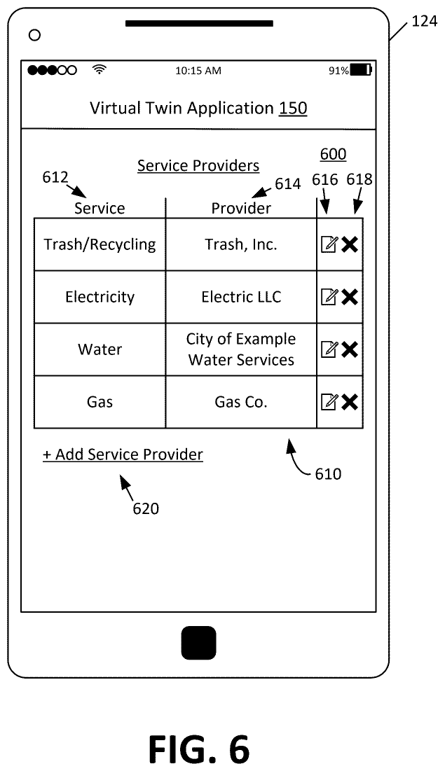

FIG. 6 illustrates an example service provider user interface 600. In the illustrated example, the service provider user interface 600 includes a list 610 of service providers. In embodiments, the list 610 of service providers includes services 614 being provided, names of the providers 612 of the services 614, and options 616, 618 to edit and delete registered service providers. The service provider user interface 600 further includes an option 620 to add a new service provider. As described above, the list 610 of service providers may be maintained in virtual twin as configuration information. In some embodiments, account credentials and other information associated with service providers may be linked to the list 610 of service providers.

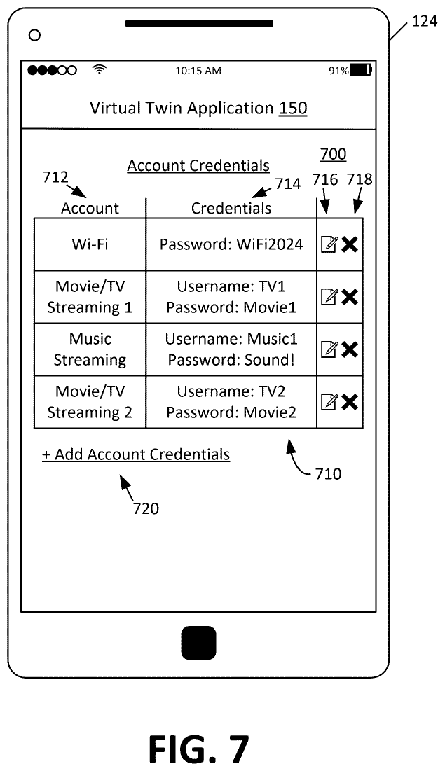

FIG. 7 illustrates an example account credentials user interface 700. In the illustrated embodiment, the account credentials user interface 700 includes a list 710 of account credentials associated with services, applications, and other accounts used within the smart dwelling. The list 710 of account credentials may include names 712 of the services and applications, account credentials 714 associated with the accounts, and options 716, 718 to edit and delete the account credentials. The account credentials user interface 700 additionally includes an option 720 to add account credentials. As described above, account credentials are maintained within the virtual twin as user preferences.

In an embodiment, the list 710 further includes an indication of which devices have access to the credentials 714 for an account. For example, a television may have access to a movie streaming service account (e.g., Movie/TV Streaming 1, as shown in FIG. 7) so that the user can watch movies on the television through the streaming service. Accordingly, the list 710 may indicate that the television has access to the credentials 714 for the movie streaming service account.

Additionally, in some embodiments, the account credentials user interface 700 may be protected to prevent unauthorized users from accessing the credentials to user accounts. In one example, the account credentials user interface 700 cannot be accessed without first authenticating the user (e.g., through a username/password or biometric authentication). In another example, the credentials 714 may be hidden until the user is authenticated.

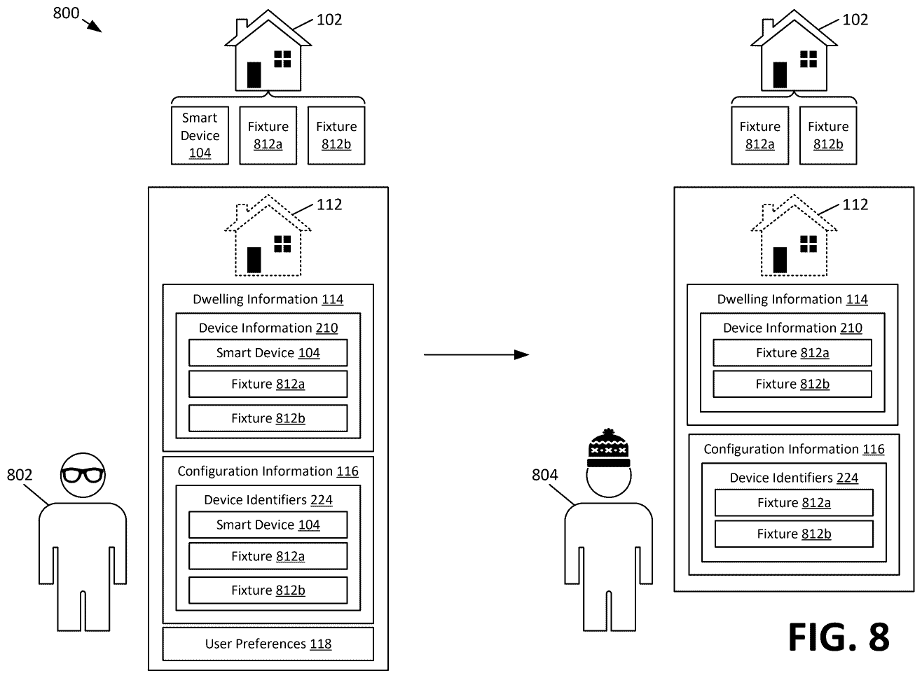

FIG. 8 illustrates an example transfer of a virtual twin 112 of a smart dwelling 102 from a seller 802 to a buyer 804. As described herein, ownership of the virtual twin 112 may transfer substantially concurrently with transfer of ownership of the smart dwelling 102. For example, the transfer of the virtual twin 112 may occur at the same time as the transfer of the smart dwelling 102. In another example, the transfer of the virtual twin 112 may occur on the same day as the transfer of the smart dwelling 102.

When the virtual twin 112 transfers from the seller 802 to the buyer 804, information included in the virtual twin 112 may be maintained through the transfer. In embodiments, some of the information included in the virtual twin 112 may be deleted before or during the transfer of the virtual twin 112 to the buyer 804.

As described above, in embodiments, the virtual twin 112 includes dwelling information 114, configuration information 116, and user preferences 118. In the illustrated example, when the virtual twin 112 is transferred from the seller 802 to the buyer 804, dwelling information 114 and configuration information 116 may be included with the transfer while user preferences 118 may be deleted before or during the transfer. For example, as explained above, the dwelling information 114 may include blueprints, floorplans, dimensions, appliance information, smart device information, maintenance and repair histories, device certificates, a virtual twin certificate, and ownership records; because this information may be is substantially fixed (i.e., the information does not change when the owner of the smart dwelling 102 changes), the dwelling information 114 may be preserved when the virtual twin 112 transfers from the seller 802 to the buyer 804. Similarly, the configuration information 116 includes a global configuration of the virtual twin 112 that is not specific to a user (such as the seller 802). Accordingly, configuration information 116 may be maintained during the transfer of ownership.

Maintaining the dwelling information 114 and the configuration information 116 may assist the buyer 804 in setting up the smart dwelling 102 for themself. In an example, each of the smart devices that stay with the smart dwelling for the transfer (i.e., the fixtures) are already set up for the buyer 804, and the buyer 804 can manage these devices through the virtual twin 112. In another example, maintaining the service providers with the configuration information 116 may provide the buyer 804 a reference for which service providers may be used to service the smart dwelling.

Because the user preferences 118 may be defined by the owner of the virtual twin 112 (i.e., the seller 802), the user preferences 118 may not carry over when the owner of the virtual twin 112 changes. In embodiments, the user preferences 118 are restored to default settings before or during the transfer.

In further examples, some user preferences 118 may be preserved through the transfer of the virtual twin 112. In an example, as described above, the user preferences 118 may include climate control settings, which may be maintained for the transfer. For example, climate control settings may be maintained so that the smart dwelling does not freeze or overheat between the seller 802 moving out and the buyer 804 moving in. In other examples, other user preferences 118 may be preserved during the transfer of the virtual twin 112.

The information in the virtual twin 112 that is maintained through the transfer process may be based on the smart devices and appliances that are identified as fixtures of the smart dwelling (i.e., the smart devices and appliances that will be transferred to the buyer 804 with the transfer of the smart dwelling 102). In embodiments, information associated with the fixtures may be maintained. For example, device settings associated with the fixtures may be maintained, even though the device settings may be included with user preferences 118.

Similarly, while much of the dwelling information 114 and configuration information 116 may be maintained during the transfer, some of the information may be deleted. For example, smart device information 210 and device identifiers 224 associated with smart devices 104 that are not fixtures may be deleted, while the information associated with fixtures 812a-b is maintained.

Additionally, as described above, the virtual twin 112 may track what information maintained therein is PII or private information. During a transfer of ownership, the virtual twin 112 may delete any PII and private information. In examples, this may include dwelling information 114 and configuration information 116 that would otherwise be maintained, such as device information 210. For example, device information 210 for a smart doorbell (which may be a fixture) may include images captured by the doorbell of individuals approaching the smart dwelling 102. This information may be deleted before or during the transfer of ownership even if the smart doorbell is a fixture and other device information 210 for the doorbell is maintained.

The transfer of the virtual twin 112 from the seller 802 to the buyer 804 may occur in different ways. In an example, the transfer may be directly from the seller 802 to the buyer 804. For example, a public ledger and blockchain-based smart contracts may be used to facilitate a direct transfer of the virtual twin 112 from the seller 802 to the buyer 804. In another example, the transfer may be indirect from the seller 802 to the buyer 804. For example, an intermediary (e.g., a bank or a real estate company) may manage the transfer of the virtual twin 112.

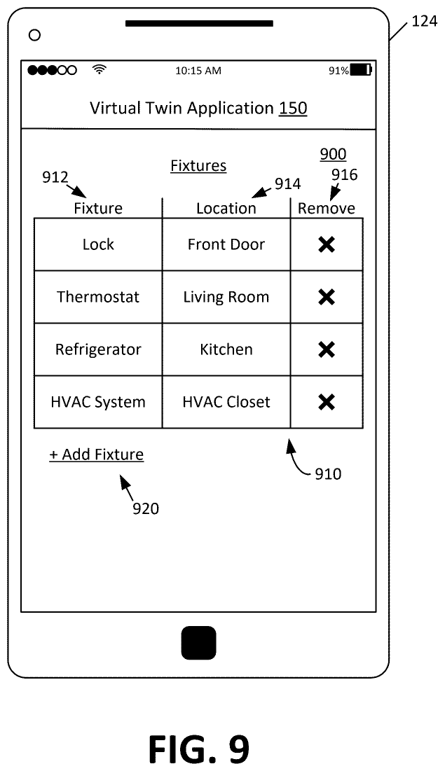

FIG. 9 illustrates an example fixture user interface 900 for identifying fixtures within the smart dwelling. As described above, the fixtures may include devices in the smart dwelling that are transferred along with the smart dwelling, and the identified fixtures may affect the information in the virtual twin that is maintained when the virtual twin is transferred.

In the illustrated embodiment, the fixture user interface 900 includes a list 910 that has names 912 and locations 914 of identified fixtures. The list 910 further includes an option 916 to remove a device from the identified fixtures. The fixture user interface 900 also includes an option 920 to add an additional fixture to the virtual twin.

Although the example fixture user interface 900 provides an example of how fixtures may be identified in a virtual twin, in some embodiments, fixtures may be identified in other ways. For example, as described above in conjunction with FIG. 4, a device settings user interface 400 may include an option 414 to identify a device as a fixture. In another example, when registering a device with the virtual twin, the device may be identified as a fixture during the registration process.

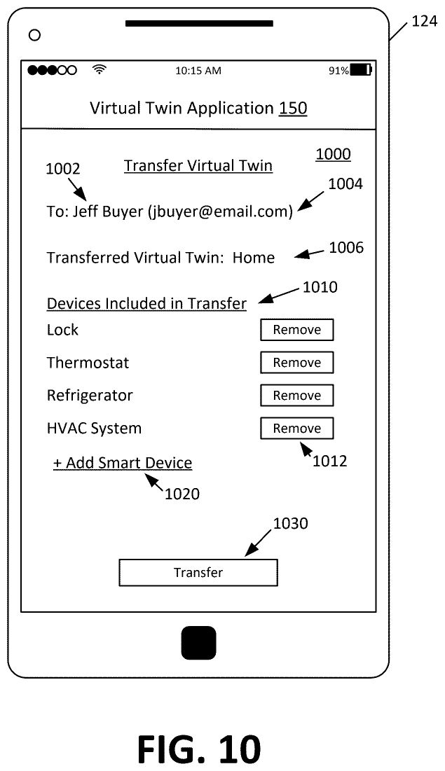

FIG. 10 illustrates an example model transfer user interface 1000. The model transfer user interface 1000 may be used to transfer ownership of the virtual twin to another user (e.g., a buyer of the smart dwelling, a financial institution, or a real estate company). In the illustrated embodiment, the model transfer user interface 1000 includes a name 1002 and contact information 1004 of the user to whom the virtual twin is being transferred (i.e., the transferee). In an example, the transferee has a virtual twin account registered with the contact information 1004 so that the virtual twin can be transferred to the transferee's virtual twin account. In alternative examples, the user to whom the virtual model is being transferred may additionally or alternatively be identified by other information, such as tax ID, and government ID, or other unique personal identifiers. The model transfer user interface 1000 additionally includes a model name 1006 of the virtual twin being transferred. In some examples, a user may own multiple smart dwellings and may therefore have multiple virtual twins, a virtual twin for each smart dwelling. The model name 1006 allows a user to confirm that the correct virtual twin is being transferred. In alternative examples, the virtual twin being transferred may additionally or alternatively be identified by a unique property identifier, such as a mailing address, a real estate ID, a tax ID, or a public ledger property ID.

In the illustrated embodiment, the model transfer user interface 1000 further includes a list 1010 of devices included in the transfer (i.e., the fixtures of the smart dwelling). As described above, the information preserved in the virtual twin for the transfer may be based on the identified fixtures. In an example, the list 1010 includes the previously identified fixtures. The model transfer user interface 1000 may include options 1012 to remove devices from the list 1010 of transferred devices. The model transfer user interface 1000 may also include an option 1020 to add another device to the list 1010 of transferred devices.

In some embodiments, the list 1010 may include a manifest of everything being transferred with the virtual twin. For example, the list 1010 may include the dwelling information, configuration information, and user preferences being included in the transfer. In an example embodiment, the list 1010 includes a manifest of all information included in the virtual twin (i.e., dwelling information, configuration information, and user preferences) and an indication of whether the information will be included in the transfer. The user can use the list 1010 to confirm that the appropriate information is being transferred and that private information and PII is not being transferred.

After the user confirms the information is correct, the user may select a transfer button 1030 to initiate the transfer to the identified user.

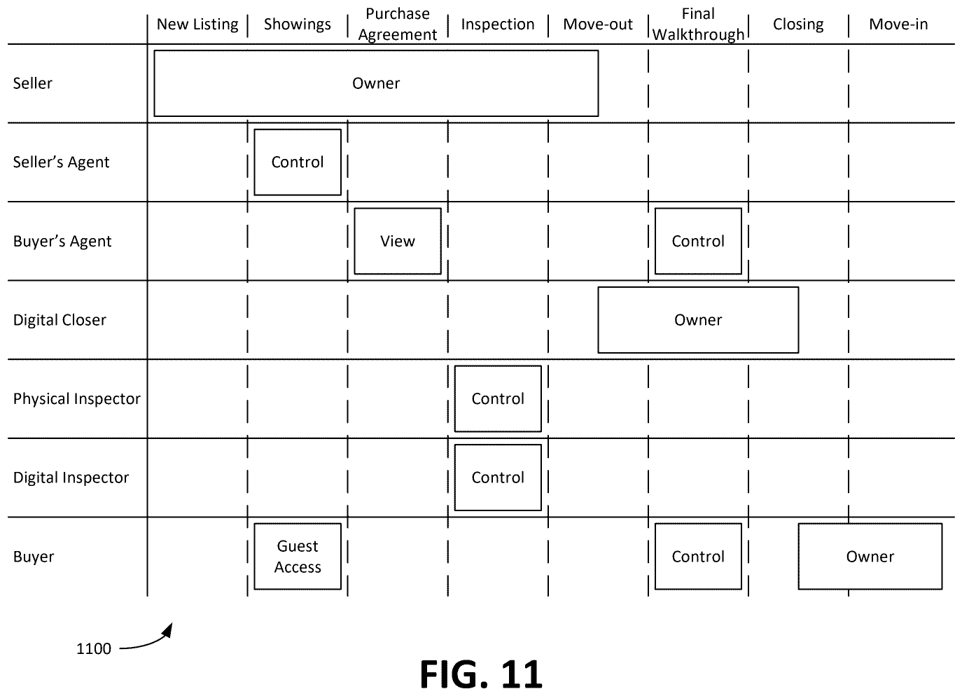

FIG. 11 illustrates an example timeline 1100 showing user permissions throughout a sale process for a smart dwelling associated with a virtual twin. In the illustrated example, permissions are shown for a seller, a seller's agent, a buyer's agent, a digital closer, a physical inspector, a digital inspector, and a buyer at different points throughout the sale process. In alternative examples, additional or alternative users may be given permissions during the sale process. Additionally, in the illustrated example, permissions are shown at multiple steps of the sale process: generating a new listing for the smart dwelling, showings, drafting a purchase agreement, showings, move-out, final walkthrough, closing, and move-in. These steps are used for an illustrative example. In alternative examples, permissions may be granted for additional or alternative steps in the sale process.

At the beginning of the sale process, the seller is the owner of the smart dwelling. Accordingly, in the illustrated example, the seller is the owner of the virtual twin at the beginning of the sale process. As the owner of the virtual twin, the seller may have full permissions within the virtual twin, including controlling devices, changing settings, and adding users, as described above.

As the owner, the seller may create a new listing for the smart dwelling on a real estate marketplace. In an example, the virtual twin may assist in creating the listing on the real estate marketplace. As described above, the virtual twin may include dwelling information about the smart dwelling, such as blueprints, floorplans, and dimensions. Information about the smart dwelling, such as blueprints, floorplans, and dimensions, may be included in the listing for the smart dwelling on the virtual marketplace. In embodiments, this information may be retrieved from the virtual twin during creation of the listing. Other information may additionally or alternatively be retrieved from the virtual twin to assist in creation of the listing on the real estate marketplace.

During showings of the smart dwelling, the seller may grant permissions to different users. For example, the seller may grant the seller's agent permissions allowing the seller's agent to control the virtual twin. By granting the seller's agent control permissions, the seller's agent can demonstrate features of the smart dwelling and the associated virtual twin to prospective buyers during the showings. In examples, the seller may grant the seller's agent permissions to control the devices in the smart dwelling but may not grant permissions to modify configuration information or user preferences in the virtual twin.

Additionally, the seller may grant the seller's agent permissions to grant limited guest access to prospective buyers during the showings. This may allow the prospective buyers to experience using the virtual twin. In embodiments, the seller's agent cannot grant permissions to prospective buyers that the seller's agent does not have. For example, if the seller's agent has permissions to control a smart television but does not have permissions to change settings of a thermostat, the seller's agent can grant prospective buyers permissions to control the smart television but cannot grant prospective buyers permissions to change settings of the thermostat. In alternative examples, the seller may grant permissions to prospective buyers. While the illustrated embodiment shows the buyer having guest access, in other examples, multiple prospective buyers may be granted permissions during the showings.

The seller may grant the buyer's agent permissions to view the virtual twin during the drafting of the purchase agreement. In an example, the purchase agreement includes terms for the sale of the smart dwelling from the seller to the buyer. For example, the purchase agreement may include a list of fixtures and other devices or appliances that are to be included in the sale of the smart dwelling. As described above, smart devices and appliances may be identified as fixtures within the virtual twin. Accordingly, this information may be used by the buyer's agent in drafting the purchase agreement. In other examples, additional or alternative information may be used by the buyer's agent to prepare the purchase agreement.

In some embodiments, in addition to permissions to view the virtual twin, the buyer's agent may be granted permissions to edit the virtual twin. For example, the buyer's agent may be given permissions that allow the buyer's agent to add devices and appliances to the list of fixtures. This may allow the buyer's agent to align the virtual twin to the terms of the purchase agreement if the purchase agreement includes fixtures that are not initially identified within the virtual twin.

In alternative embodiments, different users may be assigned permissions during the drafting of the purchase agreement. For example, if the seller's agent drafts the purchase agreement, the seller's agent may be granted the permissions discussed above. Similarly, in some embodiments, multiple users may be given permissions during the drafting of the purchase agreement. For example, both the seller's agent and the buyer's agent may have permissions to view the virtual twin: the buyer's agent may use the virtual twin to help draft the purchase agreement and the seller's agent may use the virtual twin to confirm that the purchase agreement is accurate before the seller and the buyer sign the purchase agreement.

During the inspection of the smart dwelling, inspectors may be granted permissions. In an example a physical inspector and a digital inspector may be granted permissions to control the virtual twin. The physical inspector may inspect the physical premises of the smart dwelling and verify that the smart dwelling is in acceptable condition. In an example, the physical inspector may verify that each of the devices and appliances in the smart dwelling works. Similarly, the digital inspector may inspect the virtual twin to verify that the information in the virtual twin is accurate. For example, the digital inspector may verify that certificates (e.g., device certificates and virtual twin certificate) are accurate and may verify that the ownership records are correct. While the physical inspector and the digital inspector are shown as separate entities in the illustrated example, in some examples, the same entity may perform the physical and digital inspections.

In alternative embodiments, additional users may be granted permissions for the inspection. For example, the buyer and the buyer's agent may be granted permissions if they are present for the inspection.

After the inspection, the seller moves out of the smart dwelling. During the move-out process, the seller may transfer ownership of the virtual twin to the digital closer. After ownership of the virtual twin transfers to the digital closer, the digital closer may manage the virtual twin until the sale of the smart dwelling is finalized (e.g., until closing) and the buyer takes ownership. In an example, the digital closer is a title company or an escrow agent.

In alternative embodiments, the seller may transfer ownership of the virtual twin at a different point in the sale process. For example, in an embodiment, the seller may transfer ownership of the virtual twin to the digital closer after the purchase agreement is signed. In this example, the digital closer may give the seller permissions to control the virtual twin until move-out.

The buyer and the buyer's agent may be given control of the virtual twin for the final walkthrough. Similar to the inspection, the buyer and the buyer's agent may inspect the smart dwelling and the virtual twin to verify that the smart dwelling is in an appropriate condition for closing. For example, the buyer and the buyer's agent may verify that all of the fixtures are present in the smart dwelling and verify that the virtual twin properly controls the fixtures.

Additionally, in some embodiments, during the final walkthrough, the digital closer may verify that the seller has “moved out” of the virtual twin. In an example, the digital closer may verify that data associated with the seller, such as account credentials, is removed from the smart dwelling. The digital closer may ensure that all PII and other private information associated with the seller has been removed from the virtual twin. Similarly, the digital closer may confirm that the seller no longer has control of the devices in the smart dwelling. For example, the digital closer may remove any control of the virtual twin that is still assigned to the seller. In an embodiment, the digital closer may update certificates for the smart devices. The digital closer may additionally or alternatively, the digital closer may verify that all certificates associated with the virtual twin (e.g., a virtual twin certificate and device certificates) are valid and that the integrity of the virtual twin has not been compromised. Additionally, the digital closer may update credentials of devices in the smart dwelling to ensure that the seller cannot access the devices outside of the virtual twin. For example, the digital closer may change a passcode of a smart lock so that the seller cannot use the old passcode to lock or unlock the smart lock after move-out. By verifying that data has properly been deleted from the virtual twin and ensuring the seller no longer has control over the virtual twin, both the seller and the buyer can be confident that their privacy and security are not compromised.

In another example, the digital closer may verify that the seller is the legal owner of the smart dwelling and the virtual twin. For example, the digital closer may review the history of public ledger transactions to ensure ownership of the smart dwelling and the virtual model is valid. Verifying ownership of the smart dwelling and the virtual twin may prevent fraud during the sale process.

While these examples describe the digital closer confirming that the seller does not have access to the virtual twin during the final walkthrough, in alternative examples, the digital closer may perform these steps before or after the final walkthrough. Similarly, in other examples another user may confirm that the seller no longer has access to the virtual twin. For example, the digital inspector or a third-party privacy and security auditor may perform one or more of the steps to ensure that the transaction is free of fraud and the privacy and security of the buyer and seller are protected.

At closing, the digital closer transfers ownership of the virtual twin to the buyer. For example, the transfer of ownership of the virtual twin may coincide with the transfer of ownership of the smart dwelling. After ownership transfers to the buyer at closing, the buyer can move into the smart dwelling, and the buyer has full authority over the virtual twin.

While the illustrated example shows the seller transferring ownership of the virtual twin to the digital closer and the digital closer transferring ownership of the virtual twin to the seller, in alternative embodiments, the transfer of ownership may occur without the digital closer. For example, the seller may transfer ownership of the virtual twin directly to the buyer at closing. In another example, one or more other intermediaries may be used in the transfer of ownership between the seller and the buyer. Similarly, one or more other entities may observe the transfer of ownership to ensure that the transfer is done correctly and at the correct time. For example, a bank or a real estate company may validate that the transfer of the virtual model occurs concurrently with the transfer of the smart dwelling to the buyer.

Throughout the process of transferring ownership of the virtual twin from the seller to the buyer, ownership records of the virtual twin may be updated to reflect the transfers, similar to how title records are updated for the smart dwelling. In an example, the ownership records are updated to include all transfers, including transfers to intermediaries (e.g., the digital closer). In an alternative example, the ownership records are updated to include a transfer from the seller to the buyer, even if an intermediary is used. In embodiments, as described above, the ownership records are maintained across a secure, public, distributed blockchain ledger. By maintaining the ownership records in such a ledger, fraud may be avoided by allowing public review and inspection of the ownership records, and tampering may be avoided through the distributed nature of the ledger.

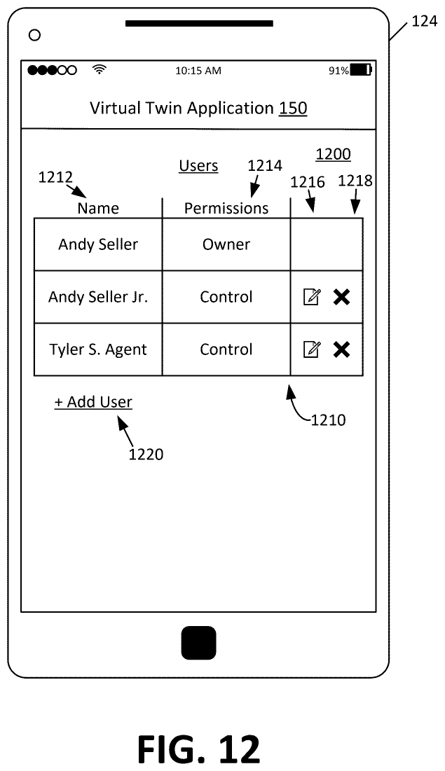

FIG. 12 illustrates an example of a user permissions user interface 1200. In the illustrated embodiment, the user permissions user interface 1200 includes a list 1210 of the users with permissions associated with the virtual twin. In an embodiment, the list 1210 includes a name 1212 of the user, permissions 1214 associated with the user, and options 1216, 1218 to edit the permissions and delete the user, respectively. The user permissions user interface 1200 may additionally include an option 1220 to add a new user.

In the illustrated example, the permissions 1214 shown for a user may be a summary of the permissions assigned to the user. For example, in some embodiments, a user may be assigned multiple permissions, as described herein. Similarly, the permissions assigned to a user may have a time limit or defined times during which the permissions are active. Rather than show each permission assigned to the user and each time limit, the permissions 1214 may instead include a brief summary of the assigned permissions. In alternative embodiments, the permissions 1214 may include each permission assigned to a user and each time limit.

In the illustrated example, the options 1216, 1218 to edit the permissions of the owner and delete the owner are not available. In embodiments, the virtual dwelling needs an owner, so the owner cannot be edited or deleted. In examples, a transfer of ownership of the virtual twin, as described above, may be used to change the owner of the virtual twin.

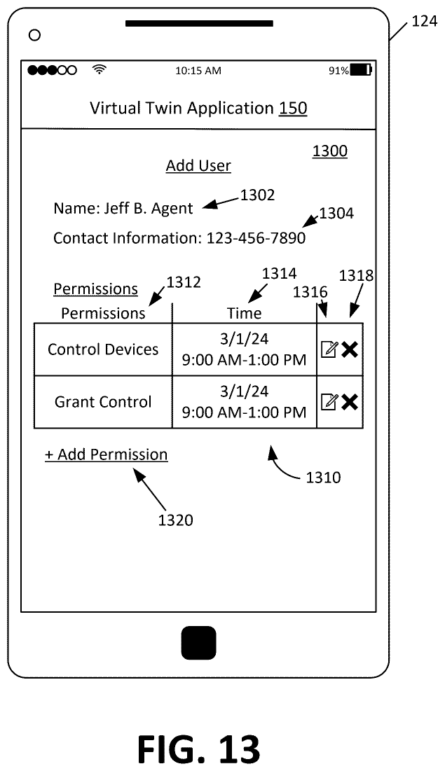

FIG. 13 illustrates an example permission assignment user interface 1300. In an example, the permission assignment user interface 1300 allows a user, such as an owner of the smart dwelling, to grant permissions to an additional user, such as an agent. In some embodiments, the permission assignment user interface 1300 may only be accessible by specific users of the virtual twin, such as the owner of the smart dwelling.

In the illustrated embodiment, the permission assignment user interface 1300 includes fields 1302, 1304 to enter a name and contact information of the user to whom permissions are being granted. The permission assignment user interface 1300 additionally includes a list 1310 of permissions to be assigned to the user. In embodiments, the list 1310 of permissions includes permissions 1312, times 1314 at which the permissions are active for the user, and options 1316, 1318 to edit and delete the permissions. In examples, the permissions 1312 provide the user access to a device or account in the smart dwelling. The time 1314 provides limits to the permissions 1312 so that the user can only use the permissions 1312 during the designated time 1314. For example, permissions 1312 assigned to an agent may be limited to a time 1314 during which the agent is performing a walkthrough of the smart dwelling. The permission assignment user interface 1300 additionally includes an option 1320 to add an additional permission 1312 to the list 1310 of permissions.

In some embodiments, permissions 1312 that are associated with a time 1314 are automatically removed after a period set by the time 1314 expires. Similarly, in some embodiments, if each of the permissions 1312 are removed (e.g., time periods associated with each permission 1312 expire), the user may automatically be removed from the virtual twin.

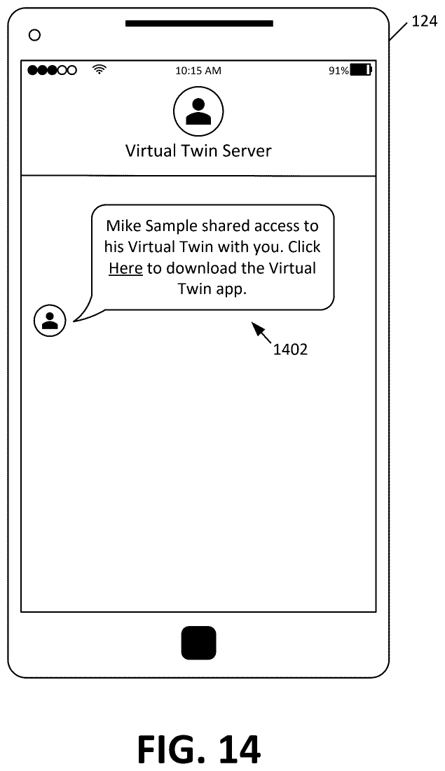

After a user is added to the virtual twin, a notification may be sent to the added user to inform the added user that they have been added to the virtual twin. FIG. 14 illustrates an example notification 1402 transmitted to an added user. In the illustrated embodiment, the notification 1402 is a text message (e.g., an SMS message). In alternative examples, the notification 1402 may be a different form of notification, such as an email message or a push notification.

The notification 1402 includes information for the added user to manage the smart dwelling and virtual twin based on the assigned permissions. In the illustrated example, the notification 1402 includes a link to download the virtual twin application, through which the added user may manage the smart dwelling and virtual twin in line with the assigned permissions. For example, the added user may create an account using the contact information with which the user received the notification 1402, and the account may automatically be given the assigned permissions. Similarly, in an embodiment, the notification 1402 includes a link to a virtual twin website through which the user can manage the smart dwelling and virtual twin in line with the assigned permissions.

In an alternative example, the notification 1402 includes credentials associated with devices to which the added user was granted access. For example, if the user was given access to a lock and a Wi-Fi network, the notification 1402 may include a passcode for the lock and a password for the Wi-Fi network.

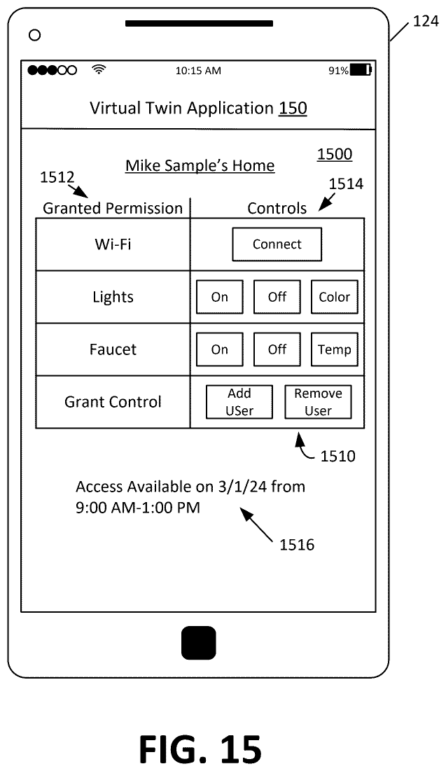

FIG. 15 illustrates an example of a limited control user interface 1500 for an added user with limited permissions. Continuing the example described above in connection with FIG. 13, a user—e.g., an agent—may be granted permissions to access a Wi-Fi network, control lights and a faucet, and grant other users permissions. In embodiments, the limited control user interface 1500 includes a list 1510 of the granted permissions 1512 and controls 1514 based on the granted permissions 1512. The limited control user interface 1500 may also include a time frame 1516 during which access is available. In the illustrated example, each of the granted permissions 1512 had the same time frame (as shown in FIG. 13), so a single time frame 1516 is displayed in the limited control user interface 1500 that applies to each of the granted permissions 1512. In some embodiments, such as those in which the granted permissions 1512 have different time periods for which they are granted, the list 1510 may include a time frame 1516 for each granted permission 1512.

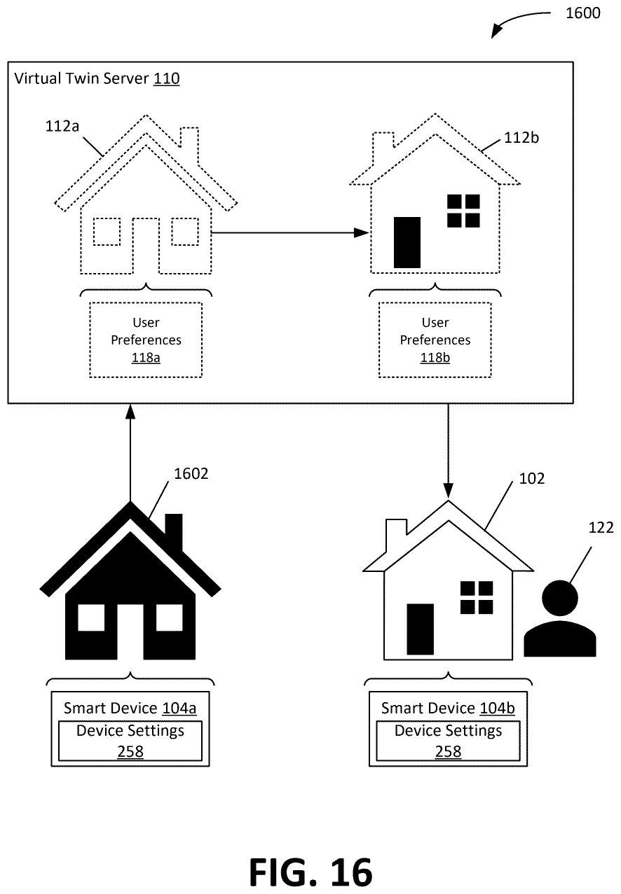

FIG. 16 illustrates a further environment 1600 in which a virtual twin of a smart dwelling is used. In the illustrated embodiment, two smart dwellings 102, 1602 are connected to the virtual twin server 110. In an example, the smart dwelling 102 is owned by a user 122, and the second smart dwelling 1602 may be a former dwelling. For example, the user 122 may have recently purchased and moved into the smart dwelling 102. Using virtual twins 112, the user 122 may change aspects of the smart dwelling 102 to be similar to the former smart dwelling 1602.

In the illustrated example, the former smart dwelling 1602 includes a smart device 104a for which the user 122 has defined device settings 258. For example, the smart device 104a may be a smart faucet, and the device settings 258 may define a preferred water temperature. As described herein, the user 122 may have created a virtual twin 112a of the former smart dwelling 1602 that includes user preferences 118, such as the device settings 258. The user 122 may also use the virtual twin 112 to align aspects of the temporary smart dwelling 1602 to the owned smart dwelling 102.

In the illustrated embodiment, the owned smart dwelling 102 includes a smart device 104b, which may be the same type of device as the smart device 104a in the former smart dwelling 1602 (e.g., the smart device 104b may also be a faucet). The user 122 may use the virtual twin 112a to apply the user preferences 118 set from the former smart dwelling 1602 to the owned smart dwelling 102. In this example, the user 122 may apply the device settings 258 that are used for the smart device 104a to the smart device 104b so that the user 122 has a similar experience with the smart device 104b as they had with the smart device 104a (e.g., the preferred temperature set for the smart device 104a may be applied to the smart device 104b).

In an embodiment, to apply the device settings 258 from the smart device 104a to the smart device 104b, user preferences 118b in a virtual twin 112b for the owned smart dwelling 102 may be updated according to the user preferences 118a in the virtual twin 112a for the former smart dwelling 1602. The virtual twin 112b for the owned smart dwelling 102 may then apply the device settings 258 to the smart device 104b in the owned smart dwelling 102.

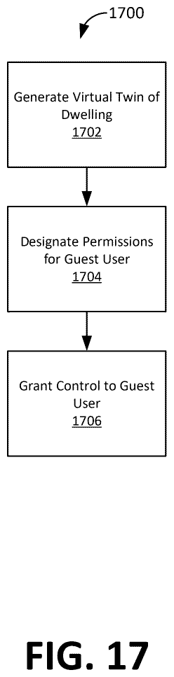

FIG. 17 illustrates a flowchart of an example method 1700 for managing ownership of a virtual twin of a smart dwelling. In the illustrated embodiment, the method 1700 includes operations 1702, 1704, 1706.

The operation 1702 includes generating a virtual twin of a smart dwelling. As described above, the virtual twin may include dwelling information, configuration information, and user preferences. In embodiments, the virtual twin of the smart dwelling allows a user, such as an owner of the smart dwelling, to control smart devices in the smart dwelling.

In examples, the information in the virtual twin is input by a user. The virtual twin may be used to control smart devices in the first smart dwelling. In an embodiment, the virtual twin is generated on a virtual twin server. The virtual twin server may be connected to the smart dwelling via a network.

The operation 1704 includes designating fixtures within the smart dwelling. In an example, the fixtures may be selected from smart devices and appliances within the smart dwelling. As described above, the fixtures may include smart devices and appliances that stay with the smart dwelling when ownership of the smart dwelling is transferred.

In an embodiment, a user, such as the owner of the smart dwelling, may designate fixates in a virtual twin application. The virtual twin may then maintain information on which devices and appliances have been designated as fixtures.

The operation 1706 includes transferring control of the virtual twin to a buyer of the smart dwelling. In an embodiment, transferring control of the virtual twin includes transferring ownership of the virtual twin to the buyer. In examples, the transfer of control of the virtual twin occurs substantially concurrently with a transfer of ownership of the smart dwelling to the buyer.

In examples, transferring control of the virtual twin to the buyer includes deleting data associated with the seller. For example, user preferences and configuration information may be deleted while dwelling information is maintained. In examples, user preferences and configuration information associated with the fixtures are maintained.

The transfer of control of the virtual twin may additionally or alternatively include removing permissions associated with the seller so that the seller cannot access the virtual twin or control smart devices in the smart dwelling after the transfer. In an example, device certificates are updated and credentials are changed, as described above.

In an embodiment, control of the virtual twin is transferred directly from a seller of the smart dwelling to the buyer. In alternative examples, one or more intermediaries are used between the buyer and the seller. For example, as described above, a digital closer may act as an intermediary (i.e., the seller transfers control of the virtual twin to the digital closer, and the digital closer transfers control of the virtual twin to the buyer).

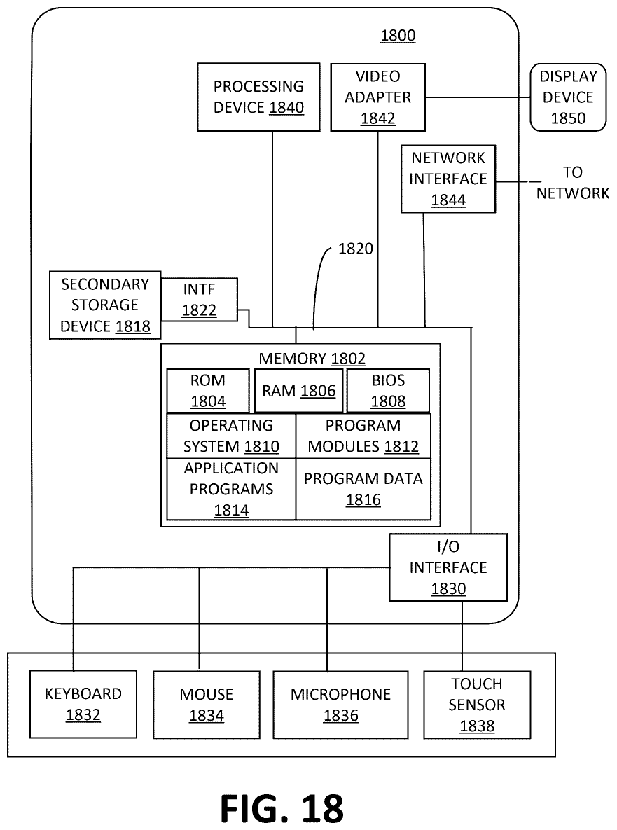

FIG. 18 illustrates an exemplary architecture of a computing device 1800 which can be used to implement aspects of the present disclosure, including the user mobile device 124 and the virtual twin server 110. The computing device 1800 is used to execute functions described herein.

The memory 1802 includes read only memory 1804 and random-access memory 1806. A basic input/output system 1808 containing the basic routines that act to transfer information within computing device 1800, such as during start up, is typically stored in the read only memory 1804.

The computing device 1800 also includes a secondary storage device 1818 in some embodiments, such as a hard disk drive, for storing digital data. The secondary storage device 1818 is connected to the system bus 1820 by a secondary storage interface 1822. The secondary storage devices 1818 and their associated computer readable media provide nonvolatile storage of computer readable instructions (including application programs and program modules), data structures, and other data for the computing device 1800.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1818 or memory 1802, including an operating system 1810, one or more application programs 1814, other program modules 1812, and program data 1814. The computing device 1800 can utilize any suitable operating system.

In some embodiments, a user provides input to the computing device 1800 through one or more input devices. Examples of input devices include a keyboard 1832, mouse 1834, microphone 1836, and touch sensor 1838 (such as a touchpad or touch sensitive display). Other embodiments include other input devices. The input devices are often connected to the processing device 1840 through an input/output interface 1830 that is coupled to the system bus 1820. These input devices can be connected by any number of input/output interfaces, such as a parallel port, serial port, game port, or a universal serial bus. Wireless communication between input devices and the interface is possible as well, and includes infrared, Bluetooth® wireless technology, 802.11a/b/g/n, cellular, or other radio frequency communication systems in some possible embodiments.

In this example embodiment, a display device 1850, such as a monitor, liquid crystal display device, projector, or touch sensitive display device, is also connected to the system bus 1820 via an interface, such as a video adapter 1842. In addition to the display device 1850, the computing device 1800 can include various other peripheral devices (not shown), such as speakers or a printer.

When used in a local area networking environment or a wide area networking environment (such as the Internet), the computing device 1800 is typically connected to the network through a network interface 1844, such as an Ethernet interface. Other possible embodiments use other communication devices. For example, some embodiments of the computing device 1800 include a modem for communicating across the network.

The computing device 1800 typically includes at least some form of computer readable media. Computer readable media includes any available media that can be accessed by the computing device 1800. By way of example, computer readable media includes computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1800.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

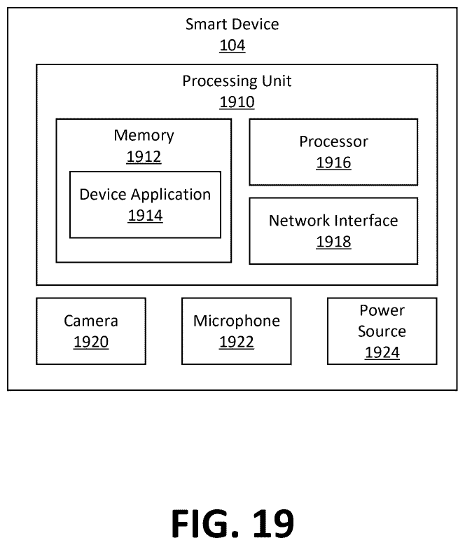

FIG. 19 illustrates an example smart device 104. The smart device includes a processing unit 1910, a camera 1920, a microphone 1922, and a power source 1924. The processing unit 1910 includes a memory 1912, a processor 1916, and a network interface 1918. The memory 1912 includes a device application 1914.

The smart device includes the processing unit 1910. The processing unit 1910 operates to control the smart device, process video data, and communicate with other devices via a network.

The processing unit includes a memory 1912, a processor 1916, and a network interface 1918. Examples of the memory 1912, processor 1916, and network interface 1918 are illustrated and described in reference to FIG. 18.

The memory 1912 includes a device application 1914. The device application 1914 operates the various functions of the smart device 104. In an example, if the smart device 104 is a smart camera device, the device application 1914 may include instructions for when video should be recorded, when different components of the smart camera should be activated (e.g., turning on the camera 1920 or the microphone 1922), providing battery status updates, initiating automations, etc.

The camera 1920 is a digital camera which contains sensors to detect light which is processed and stored as recorded images, series of images, or video (series of images or frames).

The microphone 1922 operates to record audio in conjunction with the camera 2020 recording video. In some embodiments, the smart device 104 does not include a microphone 2022.

The power source 1924 powers the smart device 104. In some embodiments, the power source 1924 is one or more batteries. In other examples, the smart device includes an AC power plug or other electrical connection. Other power sources can also be used.

In alternative embodiments, the smart device 104 may include additional or alternative components and may not include some of the components described herein, depending on the function of the smart device 104. For example, a smart television may include a display but may not include the camera 1920.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for managing control of a virtual twin of a dwelling, the method comprising:
generating a virtual twin of a dwelling, wherein the virtual twin of the dwelling includes control of one or more smart devices in the dwelling;
designating fixtures among the one or more smart devices in the dwelling; and
transferring control of the virtual twin of the dwelling from a seller to a buyer, wherein the transferred control of the virtual twin of the dwelling includes control of the designated fixtures.

2. The method of claim 1, wherein transferring control of the virtual twin of the dwelling from the seller to the buyer occurs substantially concurrently with transferring ownership of the dwelling from the seller to the buyer.

3. The method of claim 1, wherein transferring control of the virtual twin of the dwelling from the seller to the buyer includes:
deleting one or more pieces of information from the virtual twin, the one or more pieces of information including personal identifiable information associated with the seller.

4. The method of claim 3, wherein the one or more pieces of information includes data identified by the seller to be deleted in the transfer.

5. The method of claim 1, further comprising:
granting at least partial control of the virtual twin of the dwelling to an agent, the at least partial control of the virtual twin of the dwelling including control of at least one of the one or more smart devices in the dwelling.

6. The method of claim 5, further comprising:
granting, by the agent, at least partial control of the virtual twin of the dwelling to a prospective buyer, wherein the partial control of the virtual twin of the dwelling granted by the agent does not exceed the partial control granted to the agent.

7. The method of claim 5, wherein the at least partial control of the virtual twin of the dwelling includes a temporal restriction, wherein the agent has at least partial control of the virtual twin of the dwelling during a time period designated by the temporal restriction.

8. The method of claim 1, wherein transferring control of the virtual twin of the dwelling to a buyer includes:
transferring control of the virtual twin of the dwelling to an intermediary; and
transferring control of the virtual twin of the dwelling from the intermediary to the buyer.

9. The method of claim 8, wherein the intermediary verifies that personal identifiable information associated with the seller has been removed from the virtual twin.

10. The method of claim 8, wherein the intermediary verifies that the seller no longer has access to the virtual twin.

11. A system for managing control of a virtual twin of a dwelling, the system comprising:
one or more processors; and
one or more computer-readable storage devices storing data instructions that, when executed by the one or more processors, cause the system to:
generate a virtual twin of a dwelling, wherein the virtual twin of the dwelling includes control of one or more smart devices in the dwelling;
designate fixtures among the one or more smart devices in the dwelling; and
transfer control of the virtual twin of the dwelling from a seller to a buyer, wherein the transferred control of the virtual twin of the dwelling includes control of the designated fixtures.

12. The system of claim 11, wherein the transfer of control of the virtual twin of the dwelling from the seller to the buyer occurs substantially concurrently with a transfer of ownership of the dwelling from the seller to the buyer.

13. The system of claim 11, wherein to transfer control of the virtual twin of the dwelling from the seller to the buyer includes to:
delete personal data associated with the seller, the deleted personal data including data associated with smart devices not designated as fixtures.

14. The system of claim 11, wherein the data instructions further cause the system to:
grant at least partial control of the virtual twin of the dwelling to an agent, the at least partial control of the virtual twin of the dwelling including control of at least one of the one or more smart devices in the dwelling.

15. The system of claim 11, wherein the data instructions further cause the system to:
generating a real estate listing for the dwelling based, at least in part, on the virtual twin of the dwelling.

16. A non-transitory computer-readable medium having stored thereon data instructions that, when executed by one or more processors, cause the one or more processors to:
generate a virtual twin of a dwelling, wherein the virtual twin of the dwelling includes control of one or more smart devices in the dwelling;
designate fixtures among the one or more smart devices in the dwelling; and
transfer control of the virtual twin of the dwelling from a seller to a buyer, wherein the transferred control of the virtual twin of the dwelling includes control of the designated fixtures.

17. The computer-readable medium of claim 16, wherein the transfer of control of the virtual twin of the dwelling from the seller to the buyer occurs concurrently with a transfer of ownership of the dwelling from the seller to the buyer.

18. The computer-readable medium of claim 16, wherein to transfer control of the virtual twin of the dwelling from the seller to the buyer includes to:
delete personal data associated with the seller, the deleted personal data including data associated with smart devices not designated as fixtures.

19. The computer-readable medium of claim 16, wherein the data instructions further cause the one or more processors to:
grant at least partial control of the virtual twin of the dwelling to an agent, the at least partial control of the virtual twin of the dwelling including control of at least one of the one or more smart devices in the dwelling.

20. The computer-readable medium of claim 16, wherein the data instructions further cause the one or more processors to:
transfer at least partial control of the virtual twin to an intermediary, wherein the intermediary confirms ownership records of the virtual twin and the dwelling.
